(19) United States
(12) Patent Application Publication
(10) Pub. No.: US 2026/0331898 A1
(43) Pub. Date: Oct. 22, 2026

(54) BREAKER APPARATUS, CONTROL APPARATUS, INRUSH CURRENT SUPPRESSION METHOD, AND PROGRAM

(71) Applicant: NTT, Inc., Tokyo (JP)

(72) Inventors: Naoki HANAOKA, Tokyo (JP); Toru TANAKA, Tokyo (JP); Yuji HIGUCHI, Tokyo (JP); Naomichi NAKAMURA, Tokyo (JP)

(21) Appl. No.: 19/122,529

(22) PCT Filed: Nov. 14, 2022
(86) PCT No.: PCT/JP2022/042279

§ 371 Date: Apr. 18, 2025

(51) Int. Cl. H02H 3/093; H02H 3/02; H02H 3/06; H02H 3/087

(52) U.S. Cl. CPC H02H 3/093; H02H 3/021; H02H 3/066; H02H 3/087

(57) ABSTRACT

A circuit breaker device is provided with a circuit breaker unit configured to disconnect and connect a power line connecting a DC power source and a load device; and a control unit configured to control the circuit breaker unit to repeatedly disconnect and connect the power line when occurrence of an inrush current is detected.

### TECHNICAL FIELD

The present invention relates to a technology for suppressing inrush current in a power supply system.

### BACKGROUND ART

In a case such as where a new load device is connected to a DC power supply system, a large current temporarily flows through power lines. This is called inrush current. As the inrush current may result in a negative issue such as a failure of a power supply circuit, it is necessary to suppress the inrush current.

In related art, an inrush current suppression circuit (for example, a resistor or a thermistor) is provided on a load device side to suppress the inrush current, as a measure to increase the resistance of a circuit at all times or only after a circuit breaker is closed (for example, Patent Literature 1).

### CITATION LIST

### Patent Literature

Patent Literature 1: Japanese Unexamined Patent Application Publication No. 2007-116832

### SUMMARY OF INVENTION

### Technical Problem

However, in the related art that takes such a measure using the inrush current suppression circuit, a component such as the resistor, the thermistor, or a diode bridge is required, and as a result, costs increase due to the complexity of the circuit, and an increased volume occurs due to an increased number of components. Further, losses in an inserted resistor increase.

The present invention has been made in view of the above issue, and an object of the present invention is to provide a technology for enabling suppression of inrush current without providing an inrush current suppression circuit on a load device side.

### Solution to Problem

According to the present disclosure, a circuit breaker device is provided. The circuit breaker includes: a circuit breaker unit configured to disconnect and connect a power line connecting a DC power source and a load device; and a control unit configured to control the circuit breaker unit to repeatedly disconnect and connect the power line when occurrence of an inrush current is detected.

### Advantageous Effects of Invention

According to the present disclosure, it is possible to provide a technology for enabling suppression of inrush current without providing an inrush current suppression circuit on a load device side.

### BRIEF DESCRIPTION OF DRAWINGS

FIG. 1 is a diagram illustrating a configuration of a power supply system.

FIG. 2 is a diagram illustrating a waveform of an inrush current.

FIG. 3 is a diagram illustrating a waveform of an inrush current.

FIG. 4 is a diagram illustrating an example of a microgrid.

FIG. 5 is a diagram illustrating an example in which a consumer is connected to a bus in the microgrid.

FIG. 6 is a diagram illustrating a configuration example of a circuit breaker.

FIG. 7 is a diagram illustrating a configuration example of the circuit breaker.

FIG. 8 is a flowchart of inrush current suppression processing.

FIG. 9 is a diagram illustrating an example of waveforms in a case where an ON time is gradually increased.

FIG. 10 is a diagram illustrating a configuration of a system including a control device 200.

FIG. 11 is a diagram illustrating a functional configuration of the control device 200.

FIG. 12 is a diagram illustrating a hardware configuration example of the control device 200.

### DESCRIPTION OF EMBODIMENTS

Hereinafter, one or more embodiments of the present invention (present embodiment) will be described with reference to the drawings. The embodiment to be described below is a mere example, and embodiments to which the present invention is applied are not limited to the following embodiment.

In the following description, turning OFF a circuit breaker (which may also be called a circuit breaker unit or a circuit breaker device) means interrupting an electric circuit (path of current). Turning OFF the circuit breaker may also be expressed as opening the circuit breaker. Interrupting the electric circuit may also be expressed as opening the electric circuit, interrupting a current, interrupting a power line, and the like.

Turning the circuit breaker ON means connecting the electric circuit. Turning the circuit breaker ON can also be expressed as “deploying the circuit breaker”. Connecting the electric circuit can also be expressed as “connecting the power line” or “closing the electric circuit”.

The power supply system described below is a DC power supply system. However, the technology according to the present invention is applicable to systems other than DC power supply systems. Further, communication lines (which may be called networks) used in the following description are not limited to specific lines, and may be, for example, metal wires, optical fibers, or radio waves.

### Basic Configuration of Embodiment

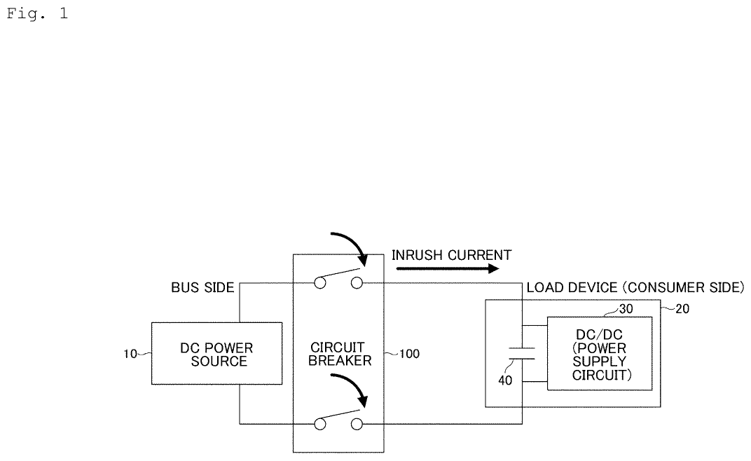

FIG. 1 illustrates a basic configuration of the power supply system according to the present embodiment. As shown in FIG. 1, in the power supply system of the present embodiment, a DC power source 10 and a load device 20 are connected by a power line, and a circuit breaker 100 is provided on the power line. The circuit breaker may also be called a circuit breaker device.

The load device 20 includes a power supply circuit 30 (DC/DC converter) and a capacitor 40 (referred to as an “X capacitor”). In the present embodiment, the capacitor 40 is provided within the load device 20, but this is a mere example. The capacitor 40 may be provided anywhere between a positive power line and a negative power line in the power supply system.

The circuit breaker 100 includes a circuit breaker unit configured to open and close (disconnection (turned OFF) and connection (turned ON) ) the power line. The circuit breaker unit may be a mechanical unit, a semiconductor unit, an electromagnetic unit, or any other unit. However, it is assumed that a circuit breaker unit with a semiconductor is used in the present embodiment. The circuit breaker that uses such a circuit breaker unit may be called a semiconductor circuit breaker. Specific examples of the configuration of the circuit breaker 100 will be described later.

It is assumed that the power supply system shown in FIG. 1 will be used, for example, in a microgrid. In a case where the power supply system is used in the microgrid, the DC power source 10 is provided on a bus side, and the load device 20 is provided on a consumer side. For this reason, FIG. 1 denotes the “bus side” and the “consumer side”.

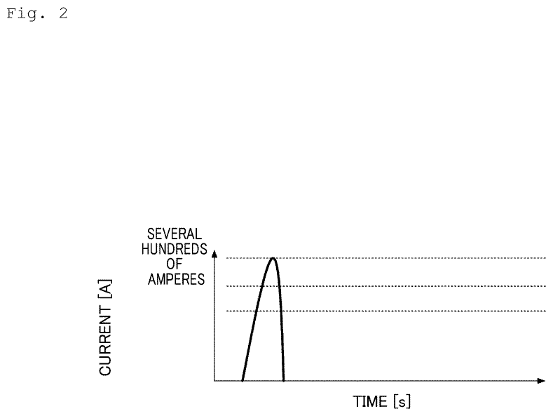

In the power supply system shown in FIG. 1, when the circuit breaker 100 is turned from OFF to ON as shown by the arrow in FIG. 1 while a current is being applied from the DC power source 10, an inrush current of, for example, several hundred amperes flows toward the capacitor 40 of the load device 20. The inrush current may cause the power supply circuit to shut down or become damaged. An example of an inrush current waveform is shown in FIG. 2.

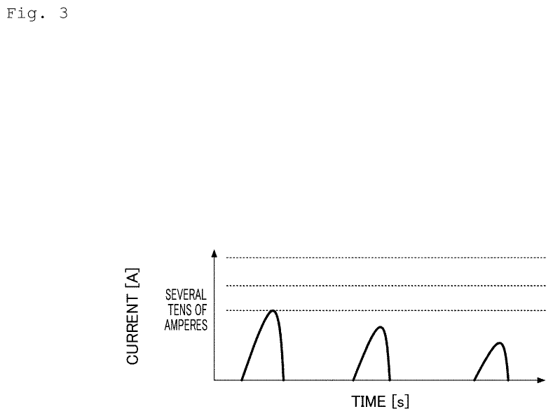

In order to suppress the inrush current as described above, in the present embodiment, when the circuit breaker 100 detects a signal indicating an event that generates inrush current (a signal indicating the start of the inrush current), the circuit breaker 100 turns the circuit breaker unit ON and OFF multiple times. A current waveform in this case is shown in FIG. 3. When the circuit breaker 100 detects that the magnitude of the current flowing through the power line has reached or exceeded a threshold, the circuit breaker 100 may determine that it has detected the occurrence of an inrush current, and may turn the circuit breaker unit ON and OFF multiple times.

When the circuit breaker unit is turned ON and OFF multiple times, the capacitor 40 can be charged intermittently. By charging the capacitor 40 (accumulating charge), the voltage of the capacitor 40 increases, and the current flowing through the power line decreases. FIG. 3 illustrates that a peak magnitude of the current decreases each time the circuit breaker unit is turned ON.

For example, the “ON time” corresponds to a length of time during which the circuit breaker unit is kept ON, and the “OFF time” corresponds to a length of time during which the circuit breaker unit is kept OFF. By periodically repeating ON time and OFF time, the waveform shown in FIG. 3 can be obtained. When the circuit breaker 100 detects that the peak magnitude of the current flowing through the power line has fallen below the threshold, the circuit breaker 100 stops turning ON/OFF and maintains an ON state.

The processing described above enables the peak of the inrush current to be reduced. Note that both the ON time and the OFF time are not limited to specific time lengths, but they are, for example, a time length in a range of about several ns to several ms. The “time length in a range of about several ns to several ms” is, for example, a time length in the range of 1 ns to 10 ms. The OFF time may be longer than the ON time. The OFF time may be, for example, about several seconds. The “about several seconds” is, for example, a time length in the range of 1 s to 10 s.

### System Configuration Example and Operational Example

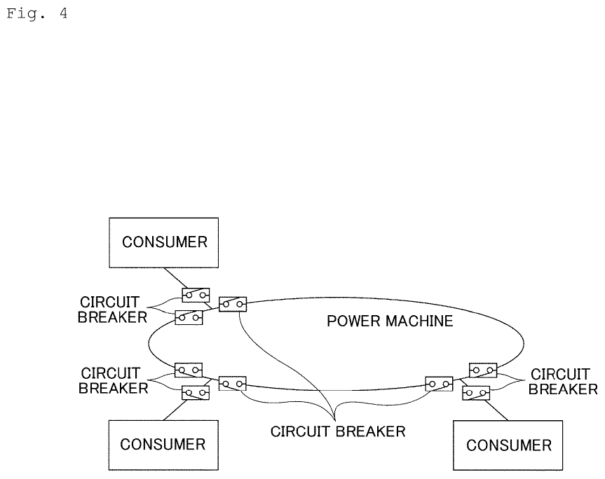

The power supply system in the present embodiment can be applied to, for example, the microgrid. As shown in FIG. 4, for example, the microgrid has a configuration in which consumers are connected to a ring-shaped power line (called a bus) via the power line. The microgrid is also provided with multiple circuit breakers. There are various types of consumers, such as loads, storage batteries, and renewable energy power generators.

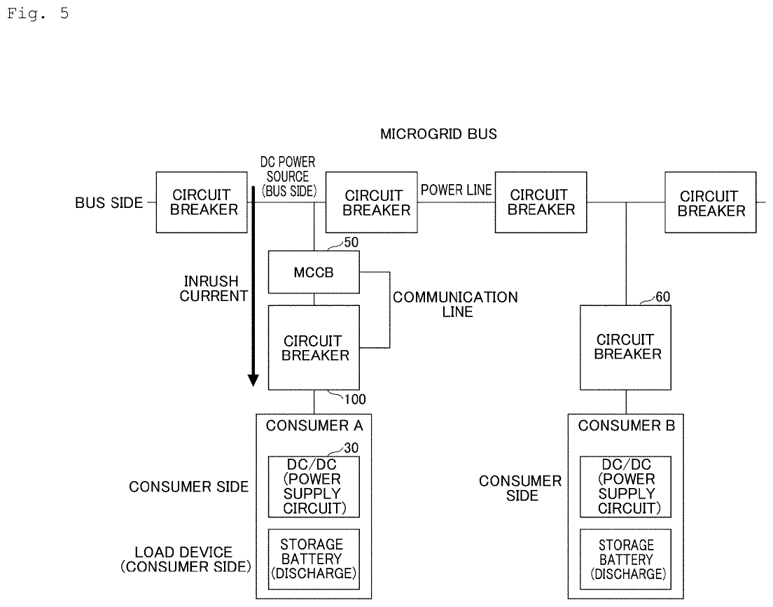

FIG. 5 is a diagram illustrating a part of the consumers connected to the bus in the entire microgrid. In an example shown in FIG. 5, the circuit breaker 100 of the present embodiment is inserted between the microgrid bus and a consumer A. The consumer A is provided with the load device 20 shown in FIG. 1, and the power supply circuit 30 is shown in FIG. 5. A microgrid bus is in a voltage-applied state, which corresponds to a state in which the DC power source 10 shown in FIG. 1 is ON.

In the example shown in FIG. 5, a molded case circuit breaker (MCCB) 50 is provided between the microgrid bus and the circuit breaker 100, and the circuit breaker 100 and the MCCB 50 are connected by a communication line. Note that the MCCB 50 need not be provided.

As described above, the microgrid bus is in the voltage-applied state. In this arrangement, if the technology related with the present invention is not employed, in either case where a new consumer A (specifically, the load device 20) is connected to the microgrid and the circuit breaker 100 is turned from OFF to ON, or where the MCCB 50 is turned from OFF to ON while the circuit breaker 100 is ON, a large inrush current would flow from the bus side to the consumer A side, and as a result, the power supply circuit 30 (specifically, the DC/CD converter) of the load device 20 might shut down. Furthermore, the inrush current may cause a voltage fluctuation on the microgrid bus, which might even shut down the power supply circuit of another consumer B that is connected to the bus.

The technology according to the present embodiment makes it possible to suppress the inrush current. In other words, the magnitude of the inrush current can be reduced.

Specifically, for example, when the new consumer A (specifically, the load device 20) is connected to the microgrid and the MCCB 50 is turned ON, a signal indicating that the MCCB 50 has been turned ON is sent to the circuit breaker 100 via the communication line.

After receiving the signal, when the circuit breaker 100 detects that the current whose magnitude is greater than or equal to a predetermined threshold has flowed through the circuit breaker 100, the circuit breaker 100 continuously turns the circuit breaker unit ON/OFF as described above to thereby charge the capacitor 40 in stages and suppress the inrush current. After receiving the signal, the circuit breaker 100 may start the control to continuously turn the circuit breaker unit ON/OFF without performing processing to detect that the current whose magnitude is greater than or equal to the predetermined threshold has flowed through the circuit breaker 100.

For example, when the new consumer A (specifically, the load device 20) is connected to the microgrid, if the MCCB 50 is in the ON state and the circuit breaker 100 turns the circuit breaker unit from OFF to ON, a signal indicating that the circuit breaker unit has been turned ON is sent to a functional unit that is inside the circuit breaker 100 and that controls turning ON/OFF.

After receiving the signal, when it is detected that the current whose magnitude is greater than or equal to the predetermined threshold has flowed through the circuit breaker 100, the functional unit continuously turns the circuit breaker unit ON/OFF as described above to thereby charge the capacitor 40 in stages and suppress the inrush current. A state in which the circuit breaker 100 is repeatedly turned ON and OFF may be referred to as an “inrush current suppression mode”. Furthermore, after receiving the signal, the functional unit may start the control to continuously turn the circuit breaker unit ON/OFF to thereby charge the capacitor 40 in stages, without performing processing to detect that the current whose magnitude is greater than or equal to the predetermined threshold has flowed through the circuit breaker 100.

Furthermore, for example, when the MCCB is in the ON state and the circuit breaker 100 receives an ON signal indicating that the power supply circuit 30 of the consumer A is turned ON, the circuit breaker 100 enters the inrush current suppression mode for a certain period of time. In the inrush current suppression mode, the circuit breaker 100 is repeatedly turned ON and OFF during a short period of time, to thereby suppress the inrush current.

In any of the above cases, when the circuit breaker 100 detects that the peak magnitude of the inrush current has fallen below the threshold while repeatedly turning the circuit breaker unit ON and OFF, the circuit breaker 100 stops the ON/OFF control and is maintained in the ON state.

Even if a current level of the inrush current that flows through the circuit breaker 100 is reduced by the ON/OFF control, the other circuit breaker 60 that is connected to the circuit breaker 100 via the power line may operate (turn OFF).

The following Examples 1 and 2 are operational examples for preventing the other circuit breaker 60 from operating erroneously due to the operation of suppression of the inrush current by the circuit breaker 100. In both Examples 1 and 2 below, it is assumed that the circuit breaker 100 and the other circuit breaker 60 are connected by the communication line.

### Example 1

When the circuit breaker 100 starts the operation of the suspension of the inrush current, the circuit breaker 100 notifies the other circuit breaker 60 of a signal indicating that the operation of the suspension of the inrush current is to be started. Upon receiving the signal, the other circuit breaker 60 performs the control such that the other circuit breaker 60 is maintained in the ON state.

When the circuit breaker 100 finishes the operation of the suppression of the inrush current, the circuit breaker 100 notifies the other circuit breaker 60 of a signal indicating that the operation of the suppression of the inrush current is to be finished. Upon receiving the signal, the other circuit breaker 60 ends the control to keep the circuit breaker 60 in the ON state, and returns to a normal state.

### EXAMPLE 2

When the circuit breaker 100 starts the operation of the suppression of the inrush current, the circuit breaker 100 notifies the other circuit breaker 60 of a signal indicating that the operation of the suppression of the inrush current is to be started. Upon receiving the signal, the other circuit breaker 60 performs control to maintain the ON state for a predetermined period of time. When this period of time has elapsed, the circuit breaker 60 ends the control to maintain the ON state and then returns to the normal state.

### Configuration Example of Circuit Breaker

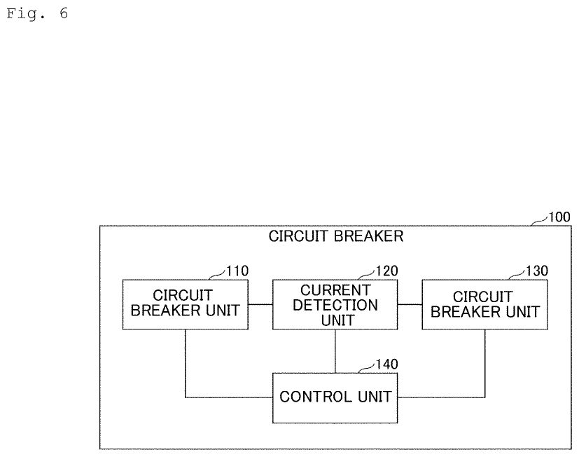

FIG. 6 shows a configuration example of the circuit breaker 100 according to the present embodiment. The circuit breaker 100 described herein may also be used as any other circuit breaker in the microgrid.

As illustrated in FIG. 6, the circuit breaker 100 in the present embodiment has a circuit breaker unit 110, a current detection unit 120, a circuit breaker unit 130, and a control unit 140. Both the circuit breaker units 110 and 130 turn the current ON/OFF (open/close) in accordance with a control signal that is from the control unit 140 and that is based on a current value measured by the current detection unit 120. The “circuit breaker” may also be called a “circuit breaker device”. Further, the “circuit breaker unit 110 and circuit breaker unit 130” may be referred to as “circuit breaker units”.

The circuit breaker unit 110 interrupts the current in one direction, and the circuit breaker unit 130 interrupts the current in a direction opposite the one direction. The control unit 140 performs processing, such as signal detection, ON/OFF control, and a threshold determination, in order to suppress the inrush current. Furthermore, as a normal operation, the control unit 140 performs an operation of sending control signals to instruct a circuit breaker unit 310 and a circuit breaker unit 330 to be turned ON/OFF based on both a current value measured by the current detection unit 120 and a preset setting value.

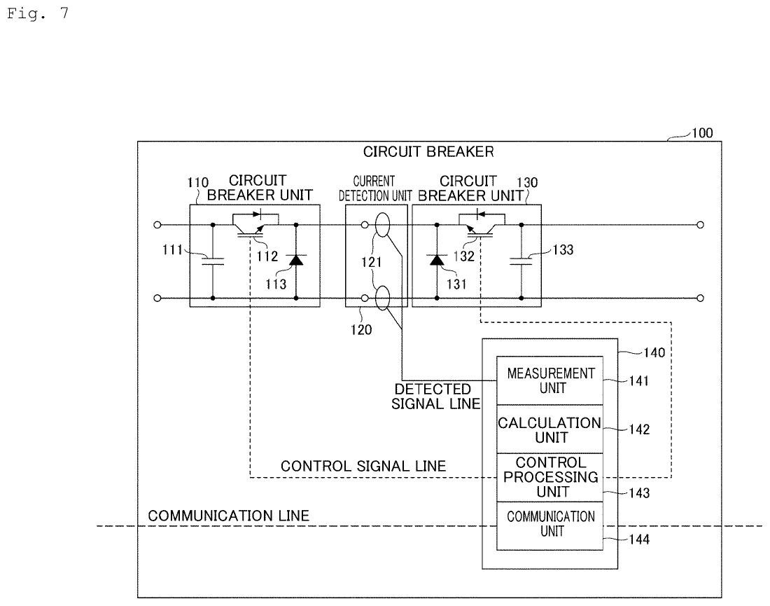

FIG. 7 illustrates a specific configuration example of the circuit breaker 100. In the example shown in FIG. 7, the circuit breaker unit 110 includes a capacitor 111, a transistor 112, and a diode 113. The current detection unit 120 includes a current sensor 121. The circuit breaker unit 130 includes a diode 131, a transistor 132, and a capacitor 133.

The transistors 112 and 132 are, for example, MOSFETS. The current sensor 121 is, for example, a Hall element or a shunt resistor. Note that the use of a capacitor or a diode at a location indicated by a corresponding number among reference numbers 111, 113, 131, and 133 is a mere example.

The control unit 140 has a measurement unit 141, a calculation unit 142, a control processing unit 143, and a communication unit 144. The measurement unit 141, the calculation unit 142, the control processing unit 143, and the communication unit 144 may all be implemented by hardware circuits, or may be implemented by causing a computer, which is comprised of a CPU and a memory, to execute a program. The communication unit 144 need not be provided.

The measurement unit 141 measures a current value based on a signal obtained from the current detection unit 120. The calculation unit 142 determines, for example, based on a current value and a setting value, whether to send control signals to instruct the circuit breaker unit 310 and the circuit breaker unit 330 to interrupt the current. The calculation unit 142 also executes a threshold determination and the like in the flow described below. The calculation unit 142 also instructs the control processing unit 143 to perform the ON/OFF control operation.

Based on an instruction from the calculation unit 142, the control processing unit 143 transmits the control signals to instruct ON/OFF to the circuit breaker unit 110 and the circuit breaker unit 130. The communication unit 144 performs communication with the control device 100 described below, communication between circuit breakers, and any other communication. The control processing unit 143 and the calculation unit 142 may be integrated into a single functional unit. This single functional unit may be called a control unit or a control processing unit.

### Operational Example

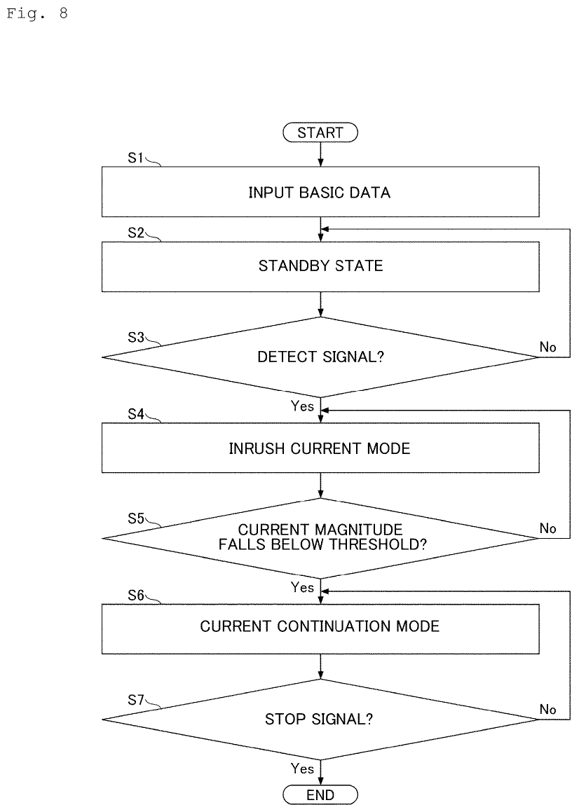

Next, a specific operational example of the circuit breaker 100 will be described in accordance with the procedure of a flowchart in FIG. 8.

In S1, basic data required for a subsequent calculation is input to the control unit 140 of the circuit breaker 100. The input basic data is stored, for example, in a data storage unit (for example, memory) in the control unit 140. The basic data includes, for example, the ON time and the OFF time of the inrush current mode, and a threshold of the current magnitude for switching to a current continuation mode (a mode in which the ON state is maintained, or a normal mode) or the like.

In S2, the control unit 140 stands by (monitors a signal). When the calculation unit 142 in the control unit 140 detects a signal indicating an event that generates the inrush current (Yes in S3), the process proceeds to S4. The “signal indicating an event that generates an inrush current” includes, for example, a signal indicating that the MCCB 50 has been turned ON, a signal indicating that a power circuit of a load device connected to the circuit breaker 100 has been turned ON, or a signal indicating that a circuit breaker unit has been turned ON.

Furthermore, the “signal indicating an event that generates an inrush current” may be a “signal indicating that a current whose magnitude is greater than or equal to a threshold has flowed through the circuit breaker 100”.

In S4, the circuit breaker 100 (specifically, the calculation unit 142) switches to the inrush current mode. In the inrush current mode, the calculation unit 142 notifies, for example, the control processing unit 143 of the specified ON time and OFF time. The control processing unit 143 performs the ON/OFF control by sending control signals to the circuit breaker units 110 and 130 in accordance with the notified ON time and OFF time.

In the inrush current mode, the measurement unit 141 measures the current flowing through the power line, using the current detection unit 120. The current measurement results are communicated to the calculation unit 142. When the calculation unit 142 detects that the peak magnitude of the current has become lower than or equal to the threshold (or below the threshold) (Yes in S5), the process proceeds to S6.

In S6, the circuit breaker 100 (specifically, the calculation unit 142) stops the ON/OFF repetition and switches to the current continuation mode. In the current continuation mode, the control processing unit 143 controls the circuit breaker units 110 and 130 so as to maintain the ON state, for example, until a stop signal is received (S6 and S7).

If a short circuit occurs during a period in which the ON state is maintained and the circuit breaker 100 detects a large current, the circuit breaker 100 turns OFF.

### ON Time and OFF Time

In the present embodiment (including modifications), the ON time and the OFF time may each be of a predetermined length or may be variable. Here, an example where the ON time and the OFF time are variable will be described. An example of control in which the ON time is gradually increased is shown below as an example of the “variable”, but control in which the ON time is gradually decreased may also be implemented.

In a case of gradually increasing the ON time, “gradually” means, for example, making the length of the ON time in the (n+1)th cycle (where n is an integer greater than or equal to 1) of the ON/OFF repetition longer than the length of the ON time in the nth cycle of the ON/OFF repetition.

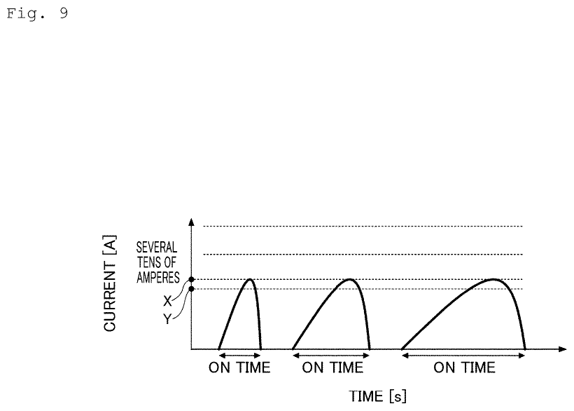

FIG. 9 shows a waveform example of the current flowing through the circuit breaker unit when the control unit 140 performs control to gradually increase the ON time when detecting the event that generates the inrush current.

In the example shown in FIG. 9, when the control unit 140 detects that, after turning the circuit breaker unit ON, a current value detected by the current detection unit 120 has reached a threshold, the control unit 140 notifies the circuit breaker unit of a signal to turn the circuit breaker unit OFF (OFF signal). If a peak current value of the waveform shown in FIG. 9 is denoted by X, the threshold is denoted by Y, which is lower than X. The reason for performing such control is that there is a time lag between sending the OFF signal and turning the circuit breaker unit OFF.

After sending the OFF signal, the control unit 140 turns the circuit breaker unit ON again, for example, after a predetermined OFF time, and when the control unit 140 detects that the current value has reached the threshold (Y), the control unit 140 sends the OFF signal to the circuit breaker unit to turn the circuit breaker OFF.

As charge accumulates in the capacitor 40 and the voltage rises, a rate at which charge accumulates in the capacitor 40 decreases. By repeating the control above, the ON time gradually becomes longer, and an amount of charge accumulated in the capacitor 40 during a single ON time can be gradually increased. As a result, the circuit breaker unit can be switched from the inrush current mode (a mode that turns the circuit breaker unit ON/OFF) to the current continuation mode (a mode in which the circuit breaker unit is constantly ON) in a shorter time, compared to control that keeps the ON time constant.

### Modifications

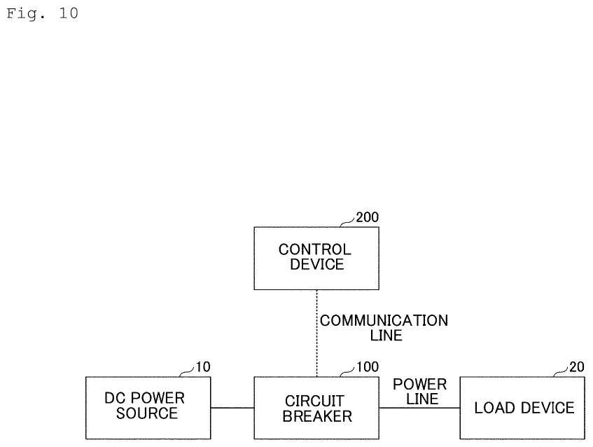

In the examples described above, the circuit breaker 100 itself determines whether to switch to the inrush current mode and performs the ON/OFF control in the inrush current mode. However, the present invention is not limited to the examples. For example, as shown in FIG. 10, a control device 200 connected to the circuit breaker 100 via the communication line may instruct the circuit breaker 100 to switch to the inrush current mode based on information acquired from the circuit breaker 100.

### Configuration Example of Control Device 200

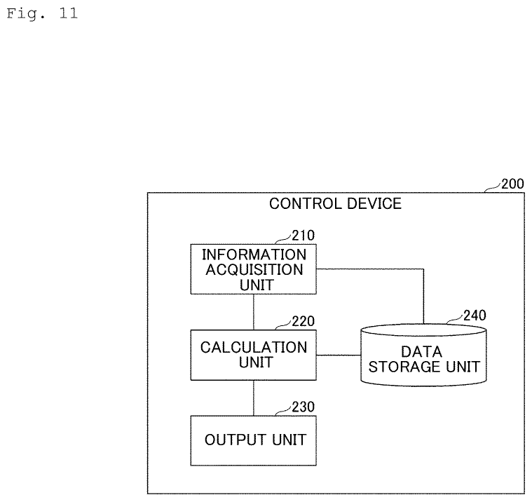

FIG. 11 illustrates a configuration example of the control device 200 in the modified example. As shown in FIG. 11, the control device 200 includes an information acquisition unit 210, a calculation unit 220, an output unit 230, and a data storage unit 240. The operation of the control device 200 equipped with these functional units will be described later. The “calculation unit 220 and output unit 230” may also be referred to as the “control unit”.

The control device 200 can be implemented, for example, by causing a computer to execute a program. This computer may be a physical computer or a virtual machine on a cloud.

That is, the control device 200 can be implemented by executing a program corresponding to processing performed by the control device 200 using hardware resources such as a CPU and a memory built into a computer. The program can be recorded on a computer-readable recording medium (for example, portable memory) and can be stored or distributed. Further, the program can also be provided through a network such as the Internet or e-mail.

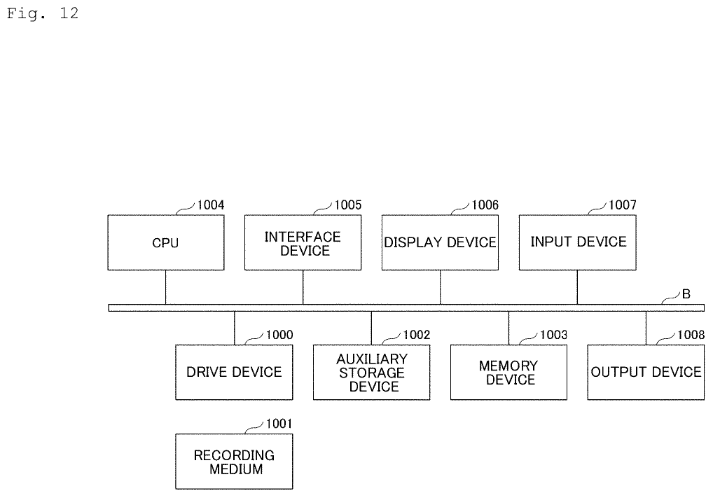

FIG. 12 is a diagram illustrating a hardware configuration example of the computer. The computer shown in FIG. 12 includes a drive device 1000, an auxiliary storage device 1002, a memory device 1003, a CPU 1004, an interface device 1005, a display device 1006, an input device 1007, and an output device 1008, which are connected to each other by a bus BS. The computer may further include a GPU.

A program for implementing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions related to the control device 200 according to a program stored in the memory device 1003. The interface device 1005 is used as an interface for, for example, connecting to a network. The display device 1006 displays, for example, a graphical user interface (GUI) according to a program. The input device 1007 is configured of, for example, a keyboard, a mouse, buttons or a touchscreen, and is used to input various operation instructions. The output device 1008 outputs calculation results.

### Operational Example of Modification

Even in the modification, the basic processing flow is the same as the flow shown in FIG. 8, so an operational example including the operation of the control device 200 will be described with reference to FIG. 8. Note that, as one example of operation, the operation based on the flow in FIG. 8 will be described below. However, even in the modification, it is possible to perform control to gradually increase the ON time as shown in FIG. 9.

In S1, basic data required for subsequent calculations is input from the information acquisition unit 210 of the control device 200. The input basic data is stored in the data storage unit 240. The basic data is, for example, the ON time and the OFF time of the inrush current mode, and a threshold of the current magnitude for switching to a current continuation mode (a mode in which the ON state is maintained, also known as a normal mode) or the like.

In S2, the control device 200 stands by (monitors a signal). When the calculation unit 220 in the control device 200 detects a signal indicating an event that generates an inrush current (Yes in S3), the process proceeds to S4. The “signal indicating an event that generates an inrush current” is as described above.

The signal may be detected by the circuit breaker 100 and transmitted from the circuit breaker 100 to the control device 200, or may be transmitted from the MCCB 50 or the load device to the control device 200. In the control device 200, the information acquisition unit 210 receives the signal and passes the signal to the calculation unit 220.

In S4, the calculation unit 220 in the control device 200 decides to switch the mode of the circuit breaker 100 to the inrush current mode, and transmits a signal to instruct the circuit breaker 100 to switch its mode to the inrush current mode from the output unit 230 to the circuit breaker 100. The control device 200 also transmits the ON time and the OFF time to the circuit breaker 100 together with the signal to instruct the circuit breaker 100 to switch its mode to the inrush current mode.

In the circuit breaker 100 that receives the signal, as well as the ON time and the OFF time, the control processing unit 143 performs the ON/OFF control by sending control signals to the circuit breaker units 110 and 130 in accordance with the communicated ON time and OFF time.

In the inrush current mode, the measurement unit 141 of the circuit breaker 100 measures the current flowing through the power line using the current detection unit 120, and the communication unit 144 transmits the measurement results to the control device 200.

When the calculation unit 220 in the control device 200 detects that the peak magnitude of the current has become lower than or equal to the threshold (or below the threshold) (Yes in S5), based on the current measurement results received from the circuit breaker 100, the process proceeds to S6.

In S6, the control device 200 transmits a signal to the circuit breaker 100 to switch its mode to the current continuation mode. Upon receiving this signal, the circuit breaker 100 switches to the current continuation mode. In the current continuation mode, the control processing unit 143 of the circuit breaker 100 controls the circuit breaker units 110 and 130 so as to maintain the ON state, for example, until a stop signal is received (S6 and S7).

### Summary of Embodiments and Effects and the Like

As stated above, with the technology described in the present embodiment, it is possible to enable the suppression of the inrush current without providing the inrush current suppression circuit on the load device side.

In other words, the technology described in the present embodiment makes it possible to achieve inrush current suppression while simplifying a circuit to reduce costs, thereby reducing the number of parts, and making the device smaller in volume. Furthermore, as compared to the related art in which the inrush current suppression circuit is provided, resistance components can be reduced, reducing constant power loss. Furthermore, it is possible to prevent the DC/DC converter from shutting down due to overvoltage from inrush current.

In the above embodiments, the following clauses are further disclosed.

### CLAUSES

### Clause 1

A circuit breaker device includes:
a circuit breaker unit configured to disconnect and connect a power line connecting a DC power source and a load device; and
a control unit configured to control the circuit breaker unit to repeatedly disconnect and connect the power line when occurrence of an inrush current is detected.

### Clause 2

In the circuit breaker device as set forth in Clause 1, the control unit is configured to determine that occurrence of an inrush current has been detected when it receives a signal indicating an event that generates the inrush current, or determine that occurrence of an inrush current has been detected when a magnitude of a current flowing through the power line becomes equal to or greater than a threshold.

### Clause 3

In the circuit breaker device as set forth in Clause 1 or 2, the control unit is configured to control the circuit breaker unit to repeatedly perform disconnection and connection during an OFF time and an ON time, respectively.

### Clause 4

In the circuit breaker device as set forth in Clause 3, the control unit is configured to control the circuit breaker unit SO that the ON time is gradually increased.

### Clause 5

In the circuit breaker device as set forth in any one of Clauses 1 to 4, the control unit is configured to bring the circuit breaker unit into a connected state when a peak of a current flowing through the power line is lower than or equal to a threshold.

### Clause 6

A control device that controls a circuit breaker device provided between a DC power source and a load device connected by a power line, the control device including: a memory; and at least one processor connected to the memory, wherein the processor is configured to: detect occurrence of an inrush current; and repeatedly disconnect and connect the power line.

### Clause 7

In an inrush current suppression method executed by a circuit breaker device, the device is provided between a DC power source and a load device connected by a power line, and the method includes the steps of:
detecting occurrence of an inrush current; and
repeatedly disconnecting and connecting the power line.

### Clause 8

A non-transitory storage medium stores a program for causing a computer to function as each unit of the control device described in Clause 5.

Although the present embodiment has been described above, the present invention is not limited to specific embodiment(s), and various modifications and changes can be made within the scope of the gist of the present invention set forth in the claims.

### REFERENCE SIGNS LIST

100 Circuit breaker
110 Circuit breaker unit
111 Capacitor
112 Transistor
113 Diode
120 Current detection unit
121 Current sensor
130 Circuit breaker unit
131 Diode
132 Transistor
133 Capacitor
140 Control unit
141 Measurement unit
142 Calculation unit
143 Control processing unit
144 Communicating part
200 Control device
210 Information acquisition unit
220 Calculation unit
230 Output part
240 Data storage unit
1000 Drive device
1001 Recording medium
1002 Auxiliary storage device
1003 Memory device
1004 CPU
1005 Interface device
1006 Display device
1007 Input device
1008 Output device

1. A breaker apparatus comprising:
a circuit breaker configured to disconnect and connect a power line connecting a DC power source and a load device; and
a controller configured to control the circuit breaker to repeatedly disconnect and connect the power line upon occurrence of a condition in which an inrush current is detected in the power line.

2. The breaker apparatus according to claim 1, wherein the controller is configured to:
receive a signal indicating an event that generates the inrush current, and determine, in response to receiving the signal, that the inrush current has been detected, or
detect that a magnitude of a current flowing through the power line is equal to or greater than a threshold, and determine that the inrush current has been detected.

3. The breaker apparatus according to claim 1, wherein the controller is configured to control the circuit breaker to repeatedly perform disconnection during an OFF time and connection during an ON time.

4. The breaker apparatus according to claim 3, wherein the controller is configured to control the circuit breaker such that the ON time gradually increases.

5. The circuit breaker apparatus according to claim 1, wherein the controller is configured to bring the circuit breaker into a connected state upon occurrence of a condition in which a peak of a current flowing through the power line is lower than or equal to a threshold.

6. A control apparatus configured to control a breaker apparatus between a DC power source and a load device that are connected by a power line, the control apparatus comprising:
circuitry configured to:
receive a signal indicating occurrence of an inrush current in the power line; and
instruct the breaker apparatus to repeatedly disconnect and connect the power line, in response to receiving the signal.

7. An inrush current suppression method executed by a breaker apparatus between a DC power source and a load device that are connected by a power line, the inrush current suppression method comprising:
detecting occurrence of an inrush current in the power line; and
repeatedly disconnecting and connecting the power line.

8. A non-transitory computer readable storage medium storing a program configured to cause a computer to execute the inrush current suppression method of claim 7.
